(19) United States
(12) Patent Application Publication
(10) Pub. No.: US 2018/0293584 A1
(43) Pub. Date: Oct. 11, 2018

(54) Fraud Monitoring Apparatus

(71) Applicant: MASTERCARD ASIA/PACIFIC PTE. LTD., Singapore (SG)

(72) Inventors: Rajat Maheshwari, Singapore (SG); Philip Wei Ping Yen, Singapore (SG)

(21) Appl. No.: 15/946,441

(22) Filed: Apr. 5, 2018

(30) Foreign Application Priority Data
Apr. 11, 2017 (SG) 10201702968T

(51) Int. Cl. G06Q 20/40; G06Q 50/00

(52) U.S. Cl. CPC G06Q 20/4016; G06Q 20/40145; G06Q 50/01; G06Q 20/401

(57) ABSTRACT

A fraud monitoring apparatus for determining a fraud score representing a relative risk of fraudulent activity for a payment request, comprising one or more processors in communication with non-transitory data storage having instructions stored thereon which, when executed by the processor or processors, cause the apparatus to perform a fraud monitoring process comprising: receiving, from an authorization server, a fraud monitoring request including transaction-related data; identifying, from said transaction-related data, an associated mobile computer device; sending a request for authentication data to the mobile computer device; receiving requested authentication data from the mobile computer device; generating a fraud score, from the received requested authentication data and the transaction-related data, representing a relative risk of fraudulent activity; and sending data representing the fraud score to the authorization server.

### CROSS-REFERENCE TO RELATED APPLICATION

This application claims the benefit of and priority to Singapore Patent Application No. 10201702968T filed Apr. 11, 2017. The entire disclosure of the above application is incorporated herein by reference.

### FIELD

The present disclosure relates in general terms to a fraud monitoring apparatus. The present disclosure also relates to a method for generating a fraud score.

### BACKGROUND

This section provides background information related to the present disclosure which is not necessarily prior art.

Financial transactions have shifted from cash to payment card based transactions due to increased convenience for both merchants and consumers alike. However, payment card based transactions are not without risk, the main issue being fraudulent transactions, that is, transactions which are carried out without the cardholder's consent.

Although there have been significant technological advances in fraud detection and prevention systems, fraud still presents a significant problem for merchants, acquiring banks and card issuing banks. In some jurisdictions, the merchants are often liable for fraudulent transactions. Once a fraudulent transaction has been identified, the transaction is often reversed, usually leaving the merchant unable to recover the fraudulently purchased goods or services. Sometimes, merchants may also have to pay an additional fee to their acquirer for permitting the fraudulent transaction to occur. These additional costs resulting from fraudulent transactions experienced by the merchant may eventually flow back to the consumers resulting in higher priced goods or services.

Cardholders typically have limited liability in the event of fraudulent transactions occurring. However, cardholders who are victims of a fraudulent transaction may find themselves without full access to funds for a short amount of time whilst the fraudulent transaction is under investigation.

In other instances, the issuing bank or other financial institution may shoulder the loss from a fraudulent transaction. The bank is typically responsible for reimbursing or reversing the transaction. It has been found to be more cost-effective to write off the loss than to pursue the person who made the fraudulent purchase. Additionally, the issuing bank often has to issue new payment cards which can be a significant expense in the long term.

To minimize fraudulent activities, systems are put in place to verify the identity of the purchaser and ensure the cardholder is making the purchase; these systems are called cardholder verification methods. Current cardholder verification methods for card-present transactions include signature verification and entry of a personal identification number (PIN) at the acceptance point.

These cardholder verification methods are not always sufficient to prevent fraud. For example, in the case of magnetic stripe cards, fraudsters may be able to obtain the payment credentials by using a card skimming apparatus. It is also possible for payment credentials to be obtained via phishing attacks or breaking into merchant databases or other locations where payment credentials are stored. The stolen payment credentials can then be used to fabricate physical cards, or to make online purchases.

It is generally desirable to provide fraud monitoring systems or processes which overcome or ameliorate one or more of the above described difficulties, or to at least provide a useful alternative.

### SUMMARY

This section provides a general summary of the disclosure, and is not a comprehensive disclosure of its full scope or all of its features. Aspects and embodiments of the disclosure are set out in the accompanying claims.

In accordance with embodiments of the present disclosure, there is provided a fraud monitoring apparatus for determining a fraud score representing a relative risk of fraudulent activity for a payment request, comprising one or more processors in communication with non-transitory data storage having instructions stored thereon which, when executed by the processor or processors, cause the apparatus to perform a fraud monitoring process comprising:

(a) receiving, from an authorization server, a fraud monitoring request including transaction-related data;

(b) identifying, from said transaction-related data, an associated mobile computer device;

(c) sending a request for authentication data to the mobile computer device;

(d) receiving requested authentication data from the mobile computer device;

(e) generating a fraud score, from the received requested authentication data and the transaction-related data, representing a relative risk of fraudulent activity; and

(f) sending data representing the fraud score to the authorization server.

In accordance with some embodiments, there is also provided a fraud monitoring method, performed by one or more processors in communication with non-transitory data storage having instructions stored thereon which are configured to determine a fraud score representing a relative risk of fraudulent activity for a payment request by:

(a) receiving, from an authorization server, a fraud monitoring request including transaction-related data;

(b) identifying, from said transaction-related data, an associated mobile computer device;

(c) sending a request for authentication data to the mobile computer device;

(d) receiving requested authentication data from the mobile computer device;

(e) generating a fraud score from the received requested authentication data representing a relative risk of fraudulent activity; and

(f) sending data representing the fraud score to the authorization server.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Embodiments of the present disclosure are hereafter described, by way of non-limiting example only, with reference to the accompanying drawings, in which:

FIG. 1 is a schematic diagram of a system for processing fraud monitoring requests;

FIG. 2 is a block diagram of a mobile computer device of the system shown in FIG. 1;

FIG. 3 is a schematic diagram showing components of an exemplary fraud monitoring apparatus of the system shown in FIG. 1;

FIG. 4 is a flow diagram showing the interoperation of the components of the system to execute the processing of fraud monitoring requests; and

FIG. 5 is a flow diagram showing the interoperations of the authorization system.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

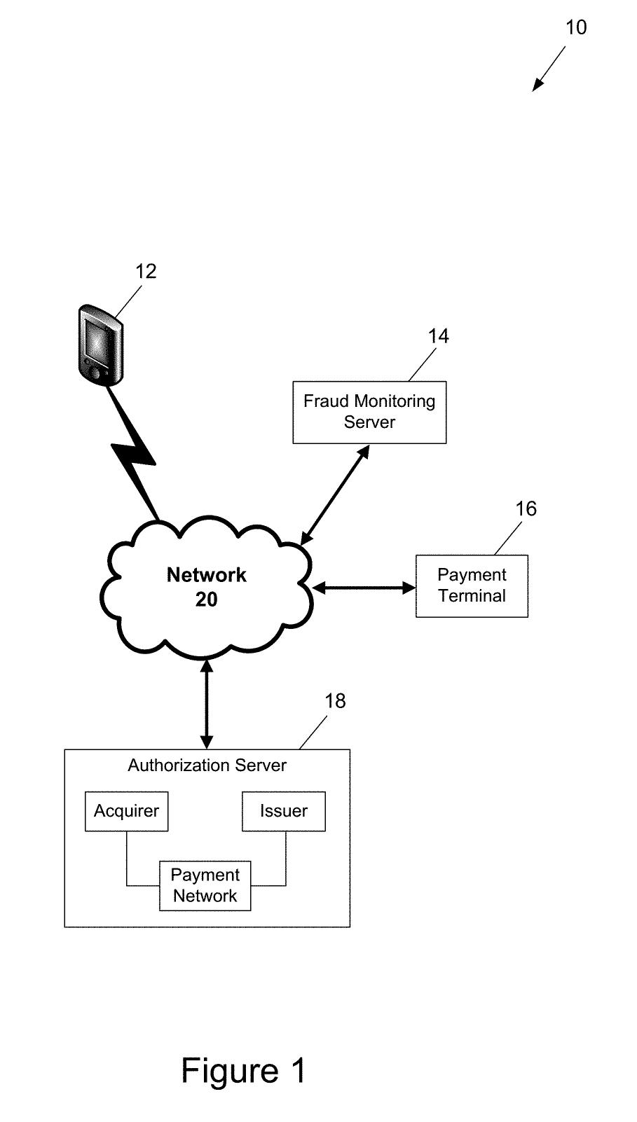

The exemplary system 10 shown in FIG. 1 allows processing of fraud monitoring requests. The system 10 comprises the following:

(a) mobile computer device 12;

(b) fraud monitoring server 14;

(c) payment terminal 16; and

(d) authorization system 18.

The components of system 10 are in communication via the network 20. The communication network 20 may include the Internet, telecommunications networks and/or local area networks.

The system 10 makes authorizing transactions more secure by introducing a fraud monitoring apparatus. Potentially fraudulent transactions can be identified by a fraud monitoring apparatus in the form of a fraud monitoring server 14 receiving cardholder identification data (and optionally, additional transaction-related data) and processing the cardholder identification data to generate a fraud score representing a relative risk of fraudulent activity for an electronic payment request. As will be described in more detail below, to generate the fraud score, the server 14 performs a fraud monitoring process comprising:

(a) receiving, from an authorization server 18, a fraud monitoring request including transaction-related data;

(b) identifying, from said transaction-related data, an associated mobile computer device 12;

(c) sending a request for authentication data to the mobile computer device 12;

(d) receiving requested authentication data from the mobile computer device 12;

(e) generating a fraud score, from the received requested authentication data and the transaction-related data, representing a relative risk of fraudulent activity; and

(f) sending data representing the fraud score to the authorization server 18.

A more detailed description of the components of the system 10 are provided below.

### Mobile Computer Device 12

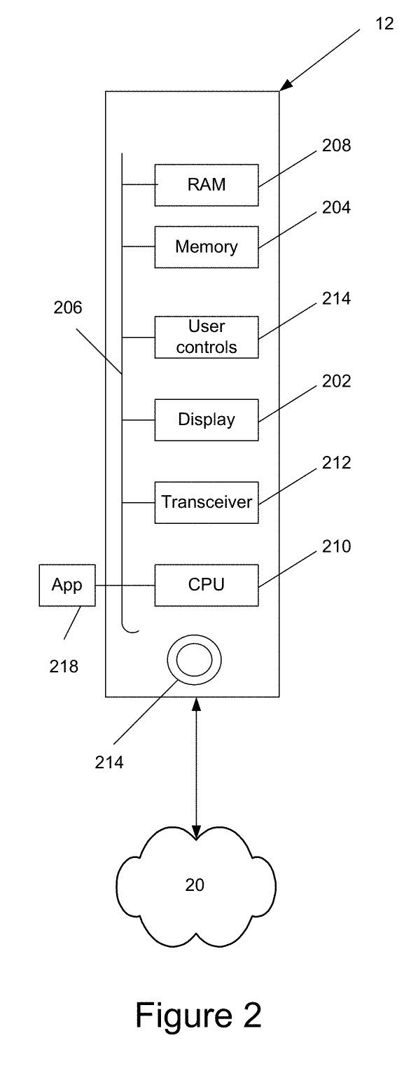

FIG. 2 is a block diagram showing an exemplary mobile computer device 12 in which embodiments of the present disclosure may be practiced. The mobile computer device 12 may be a mobile computer device such as a smart phone, a personal data assistant (PDA), a palm-top computer, and multimedia Internet enabled cellular telephones. For ease of description, the mobile computer device 12 is described below, by way of non-limiting example, with reference to a mobile computer device in the form of an iPhone™ manufactured by Apple™ Inc., or one manufactured by LG™, HTC™ and Samsung™, for example.

As shown, the mobile computer device 12 comprises the following components in electronic communication via a bus 206:

(a) a display 202;

(b) non-volatile (non-transitory) memory 204;

(c) random access memory (“RAM”) 208;

(d) N processing components 210;

(e) a transceiver component 212 that comprises N transceivers; and

(f) user controls 214.

Although the components depicted in FIG. 2 represent physical components, FIG. 2 is not intended to be a hardware diagram. Thus, many of the components depicted in FIG. 2 may be realized by common constructs or distributed among additional physical components. Moreover, it is certainly contemplated that other existing and yet-to-be developed physical components and architectures may be utilized to implement the functional components described with reference to FIG. 2.

The display 202 generally operates to provide a presentation of content to a user, and may be realized by any of a variety of displays (e.g., CRT, LCD, HDMI, micro-projector and OLED displays).

In general, the non-volatile data storage 204 (also referred to as non-volatile memory) functions to store (e.g., persistently store) data and executable code.

In some embodiments for example, the non-volatile memory 204 comprises bootloader code, modem software, operating system code, file system code, and code to facilitate the implementation components, well known to those of ordinary skill in the art, which are not depicted nor described for simplicity.

In many implementations, the non-volatile memory 204 is realized by flash memory (e.g., NAND or ONENAND memory), but it is certainly contemplated that other memory types may be utilized as well. Although it may be possible to execute the code from the non-volatile memory 204, the executable code in the non-volatile memory 204 is typically loaded into RAM 208 and executed by one or more of the N processing components 210. In some embodiments, an application or app 218 may be executed by the one or more of the N processing components 210.

The N processing components 210 in connection with RAM 208 generally operate to execute the instructions stored in non-volatile memory 204. As one of ordinarily skill in the art will appreciate, the N processing components 210 may comprise a video processor, modem processor, DSP, graphics processing unit (GPU), and other processing components.

The transceiver component 212 comprises N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

In certain embodiments, the mobile computer device 12 includes biometric authentication capabilities including one or more of the following:

(a) a fingerprint sensor;

(b) a retina scanner;

(c) microphone capable of voice recognition;

(d) camera capable of facial recognition;

(f) an iris scanner;

(g) signature or handwriting input, e.g., digitizing tablet or capacitive touchscreen.

It should be recognized that FIG. 2 is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium 204. Non-transitory computer-readable media 204 comprises both computer storage media and communication media including any medium that facilitates transfer of a computer program from one place to another. A storage medium may be any available medium that can be accessed by a computer.

### Fraud Monitoring Server 14

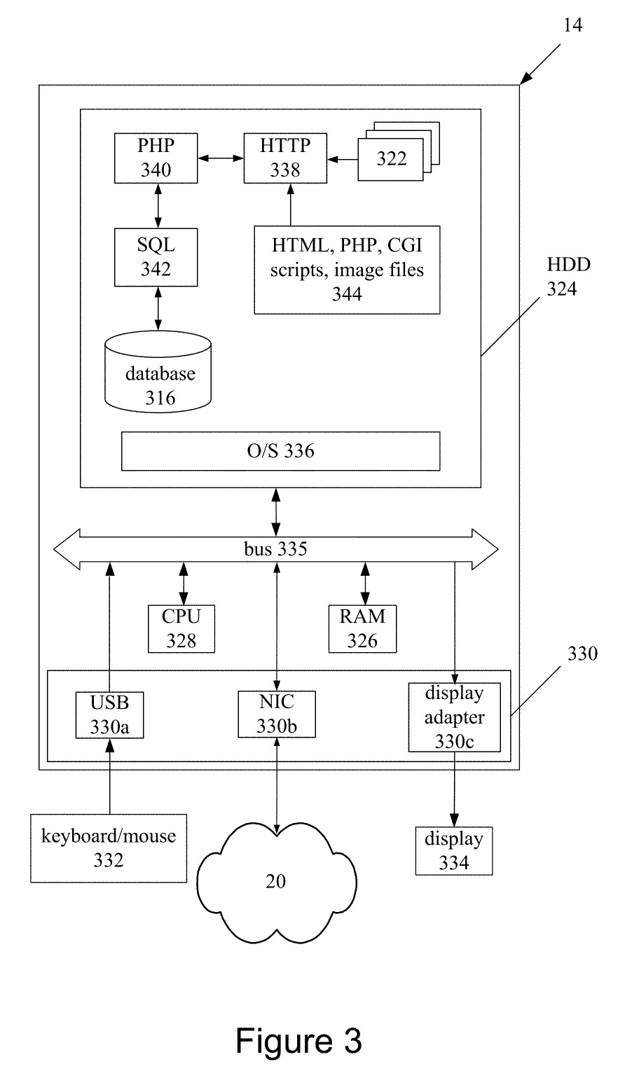

As shown in FIG. 3, the fraud monitoring apparatus may comprise a server 14. In some embodiments, the fraud monitoring apparatus may comprise multiple servers in communication with each other, for example over a local area network or a wide-area network such as the Internet. As described in a preceding section, the fraud monitoring apparatus is able to communicate with other components of the system 10 over the wireless communications network 20 using standard communication protocols.

The components of the fraud monitoring server 14 can be configured in a variety of ways. The fraud monitoring server 14 may comprise components which can be implemented entirely by software to be executed on standard computer server hardware, which may comprise one hardware unit or different computer hardware units distributed over various locations, some of which may require the communications network 20 for communication. A number of the components or parts thereof may also be implemented by application specific integrated circuits (ASICs) or field programmable gate arrays.

In the example shown in FIG. 3, the fraud monitoring server 14 is a commercially available server computer system based on a 32 bit or a 64 bit Intel architecture, and the processes and/or methods executed or performed by the fraud monitoring server 14 are implemented in the form of programming instructions of one or more software components or modules 322 stored on non-volatile (e.g., hard disk) computer-readable storage 324 associated with the fraud monitoring server 14. At least parts of the software modules 322 could alternatively be implemented as one or more dedicated hardware components, such as application-specific integrated circuits (ASICs) and/or field programmable gate arrays (FPGAs).

The fraud monitoring server 14 comprises at least one or more of the following standard, commercially available, computer components, all interconnected by a bus 335:

(a) random access memory (RAM) 326;

(b) at least one computer processor 328; and

(c) external computer interfaces 330:
(i) universal serial bus (USB) interfaces 330a (at least one of which is connected to one or more user-interface devices, such as a keyboard, a pointing device (e.g., a mouse 332 or touchpad),
(ii) a network interface connector (NIC) 330b which connects the server 14 to a data communications network, such as the wireless communications network 20; and
(iii) a display adapter 330c, which is connected to a display device 334 such as a liquid-crystal display (LCD) panel device.

The fraud monitoring server 14 comprises a plurality of standard software modules, including:

(a) an operating system (OS) 336 (e.g., Linux or Microsoft Windows);

(b) web server software 338 (e.g., Apache, available at http://www.apache.org);

(c) scripting language modules 340 (e.g., personal home page or PHP, available at http://www.php.net, or Microsoft ASP) in communication with module 344, such as HTML, PHP, CGI scripts and image files; and

(d) structured query language (SQL) modules 342 (e.g., MySQL, available from http://www.mysql.com), which allow data to be stored in and retrieved/accessed from an SQL database 316.

Advantageously, the database 316 forms part of the computer readable data storage 324. Alternatively, the database 316 is located remote from the fraud monitoring server 14 shown in FIG. 3.

The boundaries between the modules and components in the software modules 322 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the present disclosure. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the fraud monitoring server 14 may be executed by a module (of software modules 322) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The fraud monitoring server 14 normally processes information according to a program (a list of internally stored instructions such as a particular application program and/or an operating system) and produces resultant output information via input/output (I/O) devices 330. A computer process typically comprises an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, and so on) may sometimes be described as being performed by the parent process.

### Payment Terminal 16

The payment terminal 16 is a device which allows merchants to generate electronic payment requests. The payment terminal 16 is capable of interfacing with a payment device, for example by way of magnetic stripe, EMV or near field communication (NFC) technology.

In certain embodiments, the payment terminal 16 allows the merchant or his or her employee to manually enter the total transaction amount. In another embodiment, the payment terminal 16 is coupled to the merchant's point-of-sale (POS) system. The POS system stores inventory and pricing information and allows the merchant to automatically calculate the total amount due which is sent to the payment terminal to put it in readiness to receive the card details.

The payment terminal 16 may be provided to the merchant and maintained by a third party provider such as an acquirer. The payment terminal 16 is able to communicate with the authorization system 18 through standard communication protocols provided for by communications network 20.

### Authorization System 18

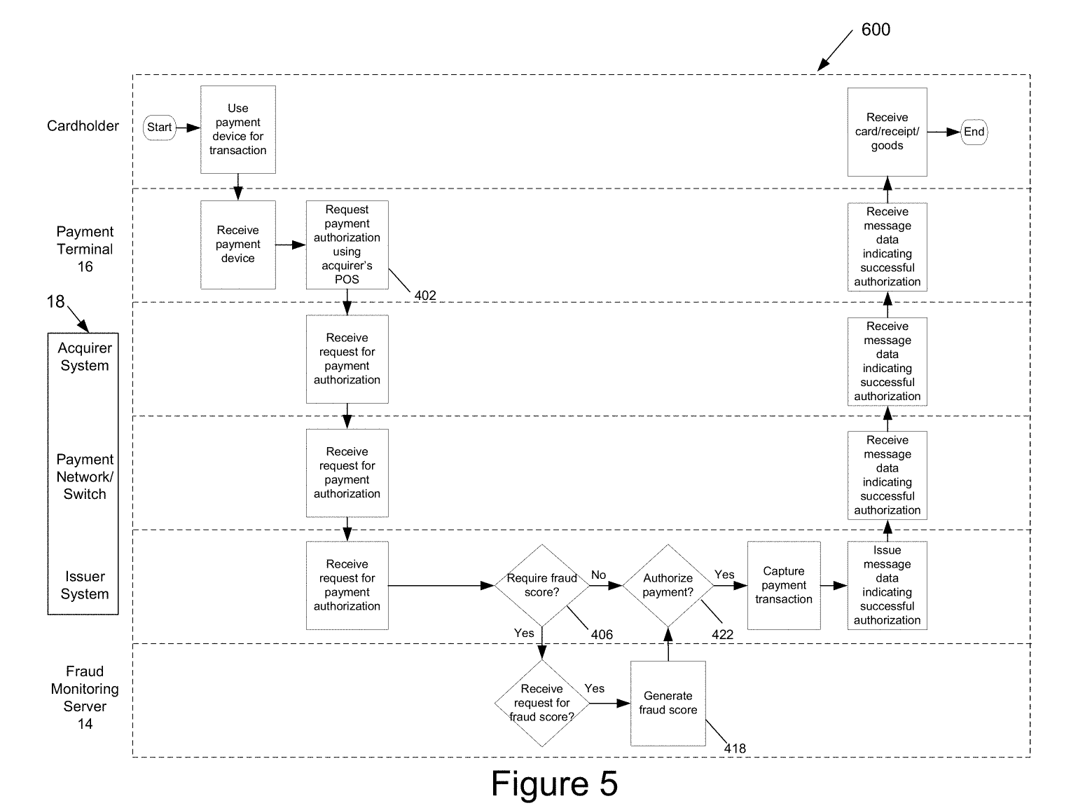

FIG. 5 shows process 600 depicting the interoperations of the authorization 18. The authorization system 18 is able to communicate with the payment terminal 16 and the fraud monitoring server 14 through standard communication protocols provided for by communications network 20, in order to receive requests for payment authorization, process such requests, and convey responses back to the payment terminal 16.

For example, the authorization system 18 may comprise an acquirer system (which may in turn comprise a core banking system in communication with an acquirer processor system), a payment network (such as Mastercard, Visa or China Unionpay) and an issuer system (which may comprise a core banking system and an issuer processor system). In certain embodiments, the acquirer processor is maintained by an acquirer or a third-party processor. In other embodiments, the issuer system can be maintained by the issuer or by a third-party system. In certain embodiments, a fraud monitoring request may be routed to the fraud monitoring apparatus from the payment network or the issuer processor.

The authorization system 18 may receive the payment authorization request via the acquirer system, which routes the request via the payment network (which acts as a switch) to the issuer system in a manner known in the art. The request may be formatted according to the ISO 8583 standard, for example, and may comprise a primary account number (PAN) of the payment instrument being used for the transaction, a merchant identifier (MID), and an amount of the transaction, as well as other transaction-related information as will be known by those skilled in the art. The issuer system receives the request, applies authorization logic to approve or decline the request, and sends an authorization response (approve or decline, optionally with a code indicating the reason for the decline) back to the acquirer system via the payment network in known fashion. The acquirer system then communicates the authorization response to the payment terminal 16.

Alternatively, in some embodiments, the authorization system 18 may receive the payment authorization request via the issuer system, which approves or declines the request (which again may be in ISO 8583 format, and comprise a PAN, MID, transaction amount and so on) and sends a response directly back to the payment terminal 16. For example, some types of cardholder-initiated payments, called “push payments”, may be initiated by a cardholder sending a request to pay a merchant (or another cardholder) to the cardholder's issuer, for example using a mobile computing device executing a digital wallet application or person-to-person (P2P) payment application or messaging platform with P2P payment functionality, such as WeChat.

In addition to processing requests for payment in which funds are actually transferred from the cardholder's account (maintained in the issuer's core banking system) to the merchant's account (maintained in the acquirer's core banking system), the authorization system 18 may process a pre-authorization (or “pre-auth”) request, in which funds are not transferred on approval of the request, but are instead placed on hold. The pre-auth can later be completed, for example by the payment terminal 16 or the merchant server, in order to release the funds. Alternatively, the pre-auth can be cancelled, thus effectively cancelling the transaction.

The operational steps for an embodiment of the present disclosure are described in further detail below.

### Fraud Monitoring Process 400

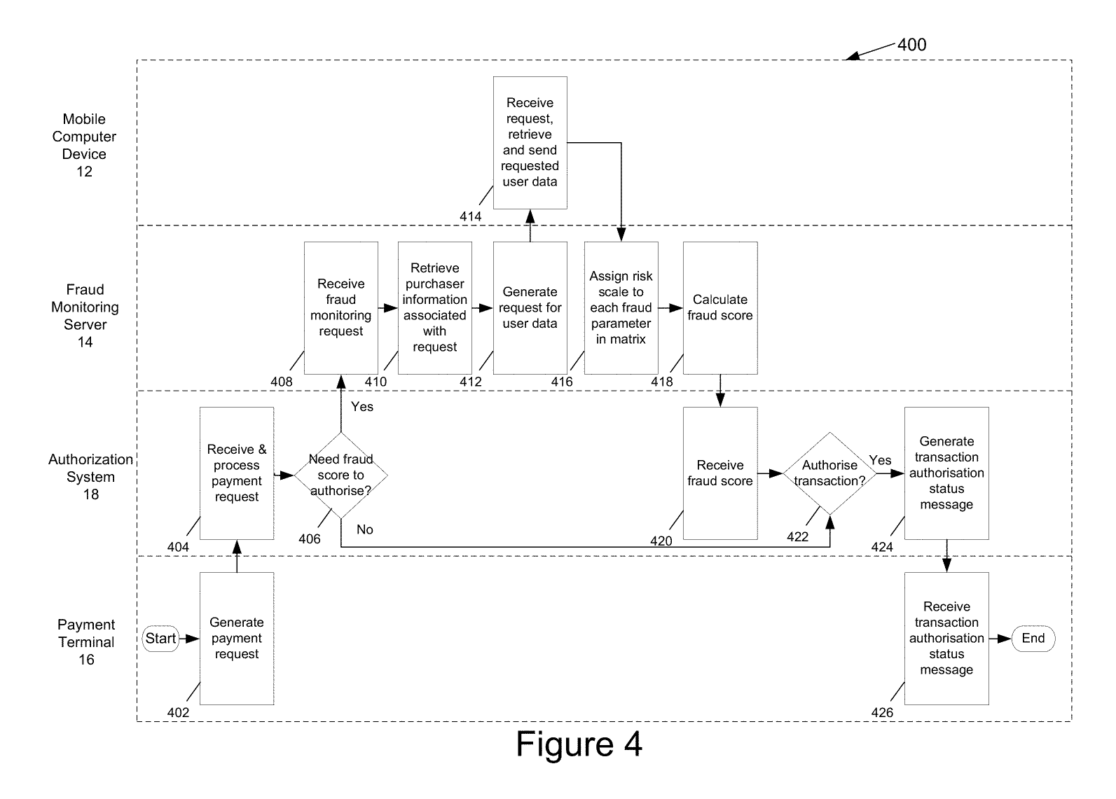

The interoperation of the components of system 10, for generating a fraud score representing a relative risk of fraudulent activity, is hereafter described by way of non-limiting example with reference to the fraud monitoring process 400 as shown in FIG. 4.

A merchant effecting a financial transaction for purchase of goods or services may be presented with a purchaser's payment device which may a physical payment card or other payment device such as a contactless fob or wearable device such as a watch, item of jewellery or fitness band having contactless payment functionality (e.g., according to the EMV contactless standard), or a mobile device such as mobile computer device 12 which executes a digital wallet application and has one or more payment cards provisioned into a digital wallet.

The payment device can be used (typically by its owner, but sometimes by the merchant) to initiate the payment request using a payment terminal 16 to interface with the payment device. The interface between the payment terminal 16 and payment device may be one of the following:

(a) magnetic stripe reader;

(b) EMV chip reader; and

(c) near field communication (NFC) reader.

These methods are known in the art and are not discussed in further detail.

The payment terminal 16 interfaces with the payment device and receives payment credentials from the payment device. The payment terminal 16 forms an authorization request message, which is then sent to the authorization system 18 for authorization. The previous section describes the interoperations of the entities within the authorization system 18.

At step 404, the authorization system 18 receives and processes the payment request for authorisation. For example, the request is received by the acquirer and sent to the issuer via a payment network. At step 406, the authorization system 18, typically the issuer system, processes the request by performing a preliminary fraud detection analysis. This may include pattern recognition algorithms or machine learning analysis. These techniques are known in the art and are not discussed further in this present disclosure. If the fraud detection analysis is inconclusive, a fraud score may be required to complete the analysis. For example, the analysis may not result in a conclusive finding of fraudulent or not fraudulent. In other embodiments, the issuer system may obtain a probability of fraudulent transaction from the fraud analysis in the range of 0% 100% for example where 0 is no risk of fraud and 100% is certain risk of fraud. In this case, the issuer system may assign a range (e.g. >70%) defining high risk transactions whereby further fraud analysis is required. In other embodiments, the issuer may detect certain spending patterns that have been associated with fraudulent transactions, and place an alert for when such patterns are detected to request for a fraud score. If the authorization system 18, typically the issuer system, requires further fraud analysis and a fraud score, the system 18 generates a fraud monitoring request and sends it to the fraud monitoring server 14.

At step 408, the fraud monitoring server 14 receives the fraud monitoring request including transaction-related data which may comprise the following:

(a) transaction information which may comprise one or more of the following:
(i) transaction total;
(ii) type of transaction; and
(iii) classification of purchase.

(b) merchant information which may comprise one or more of the following:
(i) merchant ID;
(ii) merchant's terminal ID; and
(iii) merchant's classification of goods or services.

(c) payment information which may comprise one or more of the following:
(i) payment card information;
(ii) PAN associated with the payment card; and
(iii) payment token.

At step 410, the fraud monitoring server 14 retrieves purchaser information by identifying the purchaser based on a unique identifier such as payment device credentials (e.g. PAN or token). In one embodiment where the fraud monitoring server 14 is operated by the cardholder's issuer, the purchaser information is retrieved from database 316 of the fraud monitoring server 14. In another embodiment where the fraud monitoring server 14 is operated by a third party, such as the payment network or a third party processor, the fraud monitoring server 14 requests purchaser information from the cardholder's issuer. Purchaser information may comprise one or more of the following:

(a) information associated with the purchaser's mobile computer device such as mobile phone number, identifier for an application running on the mobile computer device 12, International Mobile Equipment Identity (IMEI) and internet protocol (IP) address, global positioning system identifier;

(b) purchaser's personal details such as age, gender, spending history, credit limit and credit history; (c) purchaser's registered authentication information such as biometric, password or PIN;

(d) information associated with the purchaser's connected device(s) such as wearable computers (e.g. smartwatch, smartglasses, activity tracker, wearable sensors), headsets (e.g. virtual reality (VR) headsets), digital assistants and GPS receivers; and

(e) information associated with purchaser's social network accounts such as Facebook, Instagram, LinkedIn, WhatsApp, Orkut and Twitter.

At step 412, the fraud monitoring server 14 generates a request for user data and sends it to the purchaser's mobile computer device 12 including one or more of the following:

(a) geo-location information of the mobile computer device 12;

(b) geo-location tagged social network activities; and

(c) authentication data, such as biometric authentication data, or other user-input authentication data.

The authentication data may be requested on a per-transaction basis, or at predetermined intervals as part of a persistent authentication process.

Depending on the purchaser's mobile computer device 12 capabilities, biometric authentication may include one or more of the following:

(a) a fingerprint scan;

(b) a retina scan;

(c) voice recognition;

(d) facial recognition;

(e) hand geometry biometrics;

(f) finger geometry biometrics;

(f) an iris scan;

(g) signature recognition; and

(h) handwritten biometric recognition.

User-input authentication data may comprise one or more of the following:

(a) a password; and

(b) a personal identification number (PIN)

These authentication methods differ in terms of their inherent technical accuracy and level of security. When possible given device and/or software constraints, the strongest available user authentication method is requested first and if it is unavailable, then the next strongest method is requested as a fall-back, and so on. Preferably, biometric authentication has the highest security level, followed by a password and a PIN.

The request for user data is sent to the purchaser's mobile computer device 12 as identified in step 410. This request may be sent via a background mobile application such as an android package kit (APK), a third party (e.g. issuer) mobile application or a mobile payment application (e.g. a mobile wallet application such as SamsungPay or ApplePay). At step 414, the mobile computer device 12 receives the request for user data. The mobile computer device 12 retrieves user permission to send requested user data (either by a prompt on display 202 or retrieving pre-approved user status). The mobile computer device 12 generates data representing retrieved requested user data which is then sent to the fraud monitoring server 14.

The fraud monitoring server 14 retrieves the following information:

(a) fraud parameters;

(b) a risk level associated with each fraud parameter;

(c) risk score index; and

(d) fraud score calculation.

The data associated with the information listed above is retrieved from database 316 of the fraud monitoring server 14. In other embodiments, the information is retrieved from the issuer system of the authorization system 18. The information on database 316 can be updated by authorization system 18 or the fraud monitoring server 14 periodically or if there are developments in fraudulent activity.

In this embodiment, the fraud parameters comprise the following:

(a) transaction amount;

(b) distance between location of merchant and purchaser;

(c) deviation from historical purchaser spending behavior;

(d) purchaser risk; and

(e) purchaser authentication.

Each fraud parameter is assigned an associated risk level and risk score. For ease of description, the parameters and associated risk level and score may be displayed in the form of a table or matrix. The contents of the fraud matrix are exemplary only and may change to address new fraudulent activities.

In this embodiment, the risk level is categorised as low (L), medium (M) and high (H). In other embodiments, the risk level may be assigned an integer between 0 and 10 or any other type of categorisation. The risk level is associated with the importance of the fraud parameter in assessing fraudulent activity. For example, purchaser authentication by means of biometric authentication may be deemed very important and is thus designated a “High” risk level as user authentication is critical in determining fraudulent activity.

At step 416, the fraud monitoring server 14 receives requested user data from the mobile computer device 12. Based on the requested user data and retrieved purchaser information (from step 410), the fraud monitoring server 14 uses the retrieved risk score index and assigns a risk score to each fraud parameter. The risk score may be a number between 0 and 10 wherein 0 is low risk and 10 is very high risk. Alternative ranges for the risk score are also possible, for example 0 to 100, floating point values between 0 and 1, etc.

The risk score index provides a means of associating a risk score to each fraud parameter based on the transaction-related data, retrieved purchaser information and requested user data. The risk score index may be a look up table or an array index. The risk score index is preferably provided by the issuer system from the authorization server 18 but may be configured by any entity from the authorization server 18. The formulation of the risk score index depends on a number of factors such as country of origin for payment, type of transaction, for example.

Preferably, the authorization system 18 updates the risk score index, risk level and fraud parameters regularly to reflect fluctuations in fraudulent activity. For example, the fraud monitoring server 14 may be programmed to routinely retrieve security reports on fraudulent transactions and adjust its parameters accordingly, such as increasing the risk level for the fraud parameter, deviation of purchaser spending behavior, if more fraudulent transactions displaying this characteristic are reported.

For example, the transaction amount fraud parameter is assigned a risk score based on the transaction amount from the transaction information. For example, a transaction amount of less than $10 would result in an assigned risk score of 0 whereas a transaction amount of more than $10,000 would result in an assigned risk score of 10. For example, a risk score index for this fraud parameter may take the form of Table 1:

TABLE 1

| Risk score | Transaction From | Transaction To |
|---|---|---|
| 0 | $0 | $10 |
| 1 | $10 | $50 |
| 2 | $50 | $100 |
| 3 | $100 | $200 |
| 4 | $200 | $400 |
| 5 | $400 | $500 |
| 6 | $500 | $750 |
| 7 | $750 | $1,000 |
| 8 | $1,000 | $3,000 |
| 9 | $3,000 | $5,000 |
| 10 | $5,000 | >$5,000 |

For example, the risk score for the distance between location of merchant and purchaser fraud parameter is assigned based on the location of the merchant compared to the location of the purchaser. The assigned risk level takes into account the accuracy of the estimated location of both the merchant and the purchaser. If the accuracy of the estimated locations is high, the assigned risk level would be high. Accordingly, if it is known that the estimated locations have poor accuracies, the associated risk level would be low as the importance of that fraud parameter to the fraud score has been diminished by its inaccuracies.

The location of the merchant is determined based on the merchant information. Preferably, the payment terminal 16 which generated the payment request is identified and its location retrieved from database 316 and used as the merchant's location. The merchant's location can also be retrieved by identifying the merchant and its location of business in a merchant database which can be queried by the fraud monitoring server 14 or the authorization system 18.

The location of the purchaser can be determined by retrieving one or more of the following:

(a) geo-location information associated with the purchaser's mobile computer device 12;

(b) geo-location information associated with the purchaser's connected device(s), for example a smartwatch with inbuilt GPS receiver;

(c) purchaser's recent social network activities including geo-location-tagged activity; and

(d) network-based localization of the purchaser's mobile phone 12 based on the phone's roaming signal, if the phone is being used outside of the country of origin of the purchaser.

Preferably, the distance between location of merchant and purchaser starts with a subtraction of one from another and then associating the distance to a risk score between 0 and 10. For example, Table 2 below shows an exemplary table associating risk score to calculated distance. The associated risk scores may change depending on the country that the transaction is taking place in or the cardholder's country of origin, for example.

TABLE 2

| Risk score | Distance From | Distance To |
|---|---|---|
| 0 | 0 | 5 m |
| 1 | 5 m | 10 m |
| 2 | 10 m | 20 m |
| 3 | 20 m | 40 m |
| 4 | 40 m | 80 m |
| 5 | 80 m | 160 m |
| 6 | 160 m | 320 m |
| 7 | 320 m | 640 m |
| 8 | 640 m | 1280 m |
| 9 | 1280 m | 2560 m |
| 10 | 2560 m | >2560 m |

The risk score for the deviation from historical purchaser spending behavior fraud parameter may be assigned based on one or more of the following:

(a) purchaser's spending history; and

(b) type of transaction.

The purchaser's spending history is compared against the information of the current transaction to determine if the transaction is a recurring transaction i.e. the same product purchased from the same merchant. For example, if the purchaser often buys a snack from a vending machine at a particular location and time every work day, then a similar transaction would be assigned a 0 on the risk scale.

The risk score for the purchaser risk fraud parameter may be assigned based on one or more of the following:

(a) purchaser's age;

(b) purchaser's credit limit; and

(c) purchaser's credit history.

For example, a high purchaser risk may constitute a purchaser who is young, has a low credit limit and limited credit history. An exemplary table of risk scores for each factor is shown below in Table 3:

TABLE 3

| Risk | | | |
|---|---|---|---|
| score | Purchaser's age | Purchaser's credit limit | Purchaser's credit history |
| 0 | >48 | >$10,000 | >10 years |
| 1 | 45-48 | $7,000-$10,000 | 9-10 years |
| 2 | 42-45 | $5,000-$7,000 | 8-9 years |
| 3 | 38-41 | $4,000-$5,000 | 7-8 years |
| 4 | 35-38 | $2,000-$4,000 | 6-7 years |
| 5 | 32-25 | $1,500-$2,000 | 5-6 years |
| 6 | 29-32 | $1,250-$1,500 | 4-5 years |
| 7 | 26-28 | $1,000-$1,250 | 3-4 years |
| 8 | 23-25 | $750-$1000 | 2-3 years |
| 9 | 20-22 | $500-$750 | 1-2 years |
| 10 | <20 | <$500 | <1 year |

A final risk score for this parameter is preferably calculated using a weighted calculation. For example:

purchaser's age: 30%;

purchaser's credit limit: 30%; and

purchaser's credit history: 40%

Risk Score=0.3*purchaser age risk score+0.3*purchaser credit limit risk score+purchaser credit history*0.4

The purchaser authentication fraud parameter may be assigned based on one or more of the following:

(a) biometric authentication;

(b) user input representing authentication; and

(c) persistent authentication from purchaser's mobile computer device and/or connected device(s).

Preferably, biometric authentication is performed for purchaser authentication. The risk level for a biometric authentication by means of a fingerprint scan would be high as it is critical for determining fraudulent transactions. For example, if a fingerprint scan results in a perfect match compared to saved purchaser's fingerprint template, a risk score of 0 is assigned. If no biometric authentication is available, user-input authentication may be requested such as a password or a PIN. For example, if the user-input authentication is entered incorrectly more than 3 times, the risk score assigned may be 10.

For example, persistent authentication may occur based on a connected device such as a wearable. The authentication is typically continuous throughout the operation of the device, for example through continual contact or biometric monitoring of a heartbeat. Persistent authentication is typically valid until the wearable device is disconnected from the mobile computer device 12 or the wearable is removed from the body of the user. An example of a wearable is a smart watch connected to a mobile computer device 12. In this embodiment, if a persistent authentication is valid the risk score is 0.

After the fraud monitoring engine 14 retrieves and assigns the risk score to each fraud parameter, the fraud monitoring server 14 executes step 418 and generates a fraud score is generated by the fraud monitoring The fraud score represents a relative risk of fraudulent activity and is generated based on the risk score and risk level assigned to each fraud parameter by weighted sum calculation, for example. An exemplary fraud matrix is shown below in Table 4 with each fraud parameter being assigned a risk level and a risk score.

TABLE 4

| | Risk | Risk score (RS) | | | | | | | | | | |
|---|---|---|---|---|---|---|---|---|---|---|---|---|
| Fraud Parameters | Level (RL) | 0 | 1 | 2 | 3 | 4 | 5 | 6 | 7 | 8 | 9 | 10 |

| | | | | | | | |
|---|---|---|---|---|---|---|---|
| Transaction amount | H | | | X | | | |
| Distance between | H | | | | | | X |
| location of merchant | | | | | | | |
| & purchaser | | | | | | | |
| Deviation from | L | | X | | | | |
| historical purchaser | | | | | | | |
| spending behavior | | | | | | | |
| Crowd source data | M | | | | X | | |
| Purchaser risk | M | | | | | X | |
| Purchaser | H | X | | | | | |
| authentication | | | | | | | |

In this embodiment, the risk levels are assigned the following weight:

High: 60%;

Medium: 30%; and

Low: 10%.

$$\begin{matrix}Fraud Score = [ ( RL * Transaction amount RS ) + ( RL * Distance between \\ location of merchant \& purchaser RS ) + ( RL * Deviation \\ of purchaser spending behavior RS ) + ( RL * Crowd \\ source data RS ) + ( RL * Purchaser risk based on \\ purchaser information RS ) + ( RL * Purchaser \\ authentication RS ) ] / Σ RL \\ = ( 0.6 * 2 + 0.6 * 10 + 0.1 * 1 + 0.3 * 4 + 0.3 * 8 + 0.6 * 0 ) / 2.5 \\ = 4.36\end{matrix}$$

In other embodiments, the fraud score is a number out of 100 or any integer.

The fraud monitoring engine 14 then generates data representing the fraud score which is sent to the originating component of the authorization system 18, for example the issuer system or a third party payment processor. At step 420, the authorization system 18 receives the fraud score. At step 422, the authorization system 18 processes the payment request with the fraud score to authorize the transaction. For example, a fraud score threshold of more than 5 is defined as a high risk fraudulent transaction and any transactions with scores higher than this number will be declined. Other embodiments may define a different threshold for authorizing or declining a transaction. If the transaction is approved, the authorization system 18 executes step 424 and a transaction authorization approval message is generated and sent to the payment terminal 16. At step 426, the payment terminal 16 receives the transaction authorisation approval message.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge.

With that said, and as described, it should be appreciated that one or more aspects of the present disclosure transform a general-purpose computing deivce into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A fraud monitoring apparatus for determining a fraud score representing a relative risk of fraudulent activity for a payment request, comprising one or more processors in communication with non-transitory data storage having instructions stored thereon which, when executed by the one or more processors, cause the apparatus to:
receive, from an authorization server, a fraud monitoring request including transaction-related data;
identify, from said transaction-related data, an associated mobile computer device;
send a request for authentication data to the mobile computer device;
receive requested authentication data from the mobile computer device;
generate a fraud score, from the received requested authentication data and the transaction-related data, representing a relative risk of fraudulent activity; and
send data representing the fraud score to the authorization server.

2. The apparatus claimed in claim 1, wherein the authorization server comprises one or more of the following:
a server of an issuer processor system;
a server of a payment network; and
a server of a third party system.

3. (canceled)

4. The apparatus claimed in claim 1, wherein the transaction-related data includes payment information; and
wherein the instructions, when executed by the one or more processors, further cause the apparatus to identify a purchaser from the payment information, the payment information comprising one or more of the following:
a primary account number (PAN); and
a payment token associated with the PAN.

5. The apparatus claimed in claim 4, wherein the instructions, when executed by the one or more processors, further cause the apparatus to retrieve purchaser information associated with the identified purchaser, the purchaser information including one or more of the following:
an age of the purchaser;
a spending history of the purchaser;
a credit limit of the purchaser;
a credit history of the purchaser;
information associated with a mobile computer device of the purchaser;
information associated with a mode(s) of authentication of the purchaser;
information associated with a connected device(s) of the purchaser; and
information associated with a social network account(s) of the purchaser.

6. The apparatus claimed in claim 1, wherein the request for authentication data includes a request for one or more of the following:
geo-location information of the mobile computer device;
geo-location-tagged social network activity;
biometric authentication; and
a password or PIN.

7. The apparatus claimed in claim 1, wherein the request for authentication data includes a request for biometric authentication, the biometric authentication including one or more of the following:
a fingerprint scan;
a retina scan;
voice recognition;
facial recognition;
hand geometry biometrics;
finger geometry biometrics;
an iris scan;
signature recognition; and
handwritten biometric recognition.

8. The apparatus claimed in claim 1, wherein the instructions, when executed by the one or more processors, further cause the apparatus to generate a fraud score from fraud parameters comprising one or more of the following:
a transaction amount;
a distance between a location of a merchant and a purchaser;
a deviation from historical purchaser spending behavior;
a purchaser risk; and
a purchaser authentication.

9. The apparatus claimed in claim 8, wherein the instructions, when executed by the one or more processors, further cause the apparatus to assign a risk level to each one of said fraud parameters based on a respective level of risk of fraudulent activity.

10. The apparatus claimed in claim 8, wherein the instructions, when executed by the one or more processors, further cause the apparatus to assign a risk score to each one of said fraud parameters based on the transaction-related data, retrieved purchaser information and received requested authentication data.

11.-15. (canceled)

16. A fraud monitoring method, performed by one or more processors in communication with non-transitory data storage having instructions stored thereon which are configured to determine a fraud score representing a relative risk of fraudulent activity for a payment request, the method comprising:
receiving, from an authorization server, a fraud monitoring request including transaction-related data;
identifying, from said transaction-related data, an associated mobile computer device;
sending a request for authentication data to the mobile computer device;
receiving requested authentication data from the mobile computer device;
generating a fraud score from the received requested authentication data representing a relative risk of fraudulent activity; and
sending data representing the fraud score to the authorization server.

17. The method claimed in claim 16, wherein the authorization server includes one or more of the following:
a server of an issuer processor system;
a server of a payment network; and
a server of a third party system.

18. The method claimed in claim 17, wherein the transaction-related data comprises one or more of the following:
transaction information;
merchant information; and
payment information.

19. The method claimed in claim 16, further comprising identifying a purchaser from payment information comprising one or more of the following:
a primary account number (PAN); and
a payment token associated with the PAN.

20. The method claimed in claim 19, further comprising retrieving purchaser information associated with the identified purchaser, the purchaser information including one or more of the following:
an age of the purchaser;
a spending history of the purchaser;
a credit limit of the purchaser;
a credit history of the purchaser;
information associated with a mobile computer device of the purchaser;
information associated with a mode(s) of authentication of the purchaser;
information associated with a connected device(s) of the purchaser; and
information associated with a social network account(s) of the purchaser.

21. The method claimed in claim 16, wherein the request for authentication data comprises a request for one or more of the following:
geo-location information of the mobile computer device;
geo-location-tagged social network activity;
biometric authentication; and
a password or PIN.

22. The method claimed in claim 16, wherein the request for authentication data includes a request for biometric authentication, the biometric authentication including one or more of the following:
a fingerprint scan;
a retina scan;
voice recognition;
facial recognition;
hand geometry biometrics;
finger geometry biometrics;
an iris scan;
signature recognition; and
handwritten biometric recognition.

23. The method claimed in claim 16, further comprising generating a fraud score from fraud parameters comprising one or more of the following:
a transaction amount;
a distance between a location of a merchant and a purchaser;
a deviation from historical purchaser spending behavior;
a purchaser risk; and
a purchaser authentication.

24. The method claimed in claim 23, further comprising assigning a risk level to each one of said fraud parameters based on a respective level of risk of fraudulent activity.

25. The method claimed in claim 23, further comprising assigning a risk score to each one of said fraud parameters based on the transaction-related data, retrieved purchaser information and received requested authentication data.

26.-30. (canceled)
